(19) United States
(12) Patent Application Publication
(10) Pub. No.: US 2024/0097876 A1
(43) Pub. Date: Mar. 21, 2024

(54) Clock queue with arming and/or self-arming features

(71) Applicant: MELLANOX TECHNOLOGIES, LTD., Yokneam (IL)

(72) Inventors: Dotan David Levi, Kiryat Motzkin (IL); Ariel Shahar, Jerusalem (IL); Shahaf Shuler, Kibbutz Lohamei Hagetaot (IL); Ariel Almog, Kohav Yair (IL); Eitan Hirshberg, Pardes Hana Karkur (IL); Natan Manevich, Ramat Hasharon (IL)

(21) Appl. No.: 18/523,991

(22) Filed: Nov. 30, 2023

Related U.S. Application Data
(63) Continuation of application No. 17/335,122, filed on Jun. 1, 2021, now Pat. No. 11,876,885.
(60) Provisional application No. 63/047,275, filed on Jul. 2, 2020.

(51) Int. Cl. H04L 7/00

(52) U.S. Cl. CPC H04L 7/0091

(57) ABSTRACT

A communication system includes at least one send queue, containing send queue entries pointing to packets to be transmitted over a network by packet sending circuitry. A clock work queue contains clock queue entries to synchronize sending times of the packets pointed to by the send queue entries. At least one arming queue contains arming queue entries to arm the clock work queue at selected time intervals.

### RELATED APPLICATION INFORMATION

The present application is a continuation of U.S. patent application Ser. No. 17/335,122, filed 1 Jun. 2021, which claims priority from U.S. Provisional Patent Application Ser. No. 63/047,275 of Ariel Shahar et al, filed 2 Jul. 2020, the disclosure of which is hereby incorporated herein by reference.

### FIELD OF THE INVENTION

The present invention relates in general to systems and methods for accurate scheduling, including, but not limited to, accurate scheduling of packet transmission and related technologies, and specifically but not exclusively to such systems and methods in the context of a clock queue.

### BACKGROUND OF THE INVENTION

Various systems and methods intended to allow accurate scheduling of packet transmission are known. Some examples are described in the following pending US patent application: U.S. patent application Ser. No. 16/430,457 of Levi et al, published as US Published Patent Application 2019/0379714, the disclosure of which is hereby incorporated herein by reference.

The concept of memory protection, which is described, for example, in en.wikipedia.org/wiki/Memory_protection, may be useful in understanding certain embodiments of the present invention.

### SUMMARY OF THE INVENTION

The present invention, in certain exemplary embodiments thereof, seeks to provide improved systems and methods for accurate scheduling of packet transmission and related technologies.

In certain exemplary embodiments, the present invention may be useful in the following scenario:
Communication Networks such as Enhanced Common Public Radio Interface (eCPRI), Optical Data center Network (ODCN), video over IP (e.g., Society of Motion Picture and Television Engineers (SMPTE) 2110) and others, use Time Division Multiplex (TDM) or, sometimes, Time-Division-Multiple Access (TDMA) for communicating between endpoints, wherein a plurality of data sources share the same physical medium during different time intervals, which are referred to as timeslots.
eCPRI is described, for example, in eCPRI Specification V2.0 (2019 May 10), by Ericsson A B, Huawei Technologies Co. Ltd, NEC Corporation and Nokia. One relevant implementation of eCPRI is described in the O-RAN specification. Optical datacenter networks are described, for example, in “NEPHELE: an end-to-end scalable and dynamically reconfigurable optical architecture for application-aware SDN cloud datacenters,” IEEE Communications Magazine (Volume: 56, Issue: 2, February 2018. DOI: 10.1109/MCOM.2018.1600804), by Paraskevas Bakopoulos et al.
TDMA multiplexing in high performance networks requires good synchronization between the end points, which is usually achieved by high precision time bases. Specialized circuitry, such as that described by Xilinx RoE Framer IP documentation (Xilinx PB056 (v2.1) Oct. 30, 2019) may also be used to send and receive data in TDM network; however, such specialized circuitry may be expensive and inflexible.
Certain exemplary embodiments of the present invention seek to provide network-time dependent network communications using network elements, including inexpensive network adapters such as Network Interface Controllers (NICs) in the context of Ethernet™, or Host Channel Adapters (HCAs) in the context of InfiniBand. While the description below focuses mainly on embodiments suitable for network adapters, the disclosed techniques are not limited to network adapters, and may be used with any suitable network elements, including, for example, switches and routers.

It is appreciated that, in certain exemplary embodiments, the present invention may also be used in scenarios involving one or more of the following: TDM Networking; optical switching; and time sensitive networking.

There is thus provided in accordance with an exemplary embodiment of the present a timing system including timing circuitry including an arming queue, a clock work queue, and a clock completion queue, wherein at least the clock work queue is to provide timing information, and the arming queue is to arm the clock work queue.

Further in accordance with an exemplary embodiment of the present invention the clock completion queue is also to provide timing information.

Still further in accordance with an exemplary embodiment of the present invention the clock work queue is for synchronizing a sending time of packets pointed to by entries in a send queue to hold entries pointing to packets to be transmitted, via interaction with the clock completion queue.

Additionally in accordance with an exemplary embodiment of the present invention the send queue is associated with an application running in a host external to the timing system.

Moreover in accordance with an exemplary embodiment of the present invention the send queue includes a plurality of send queues, each of which is associated with an application running in a host external to the timing system.

Further in accordance with an exemplary embodiment of the present invention at least one of the clock work queue and the clock completion queue is implemented in firmware.

Still further in accordance with an exemplary embodiment of the present invention the send queue includes a plurality of send queues each of which is associated with an application running in a host external to the timing system, and a least one application is associated with a different protection domain than at least one other application.

Additionally in accordance with an exemplary embodiment of the present invention the timing system also includes packet sending circuitry to transmit one or more packets over a network, wherein the packet sending circuitry is further to transmit the one or more packets in accordance with the sending time of corresponding entries in the send queue.

Moreover in accordance with an exemplary embodiment of the present invention the timing circuitry is included in a network interface card (NIC).

Further in accordance with an exemplary embodiment of the present invention the packet sending circuitry and the timing circuitry are included in a network interface card (NIC).

Still further in accordance with an exemplary embodiment of the present invention the arming queue includes at least a first arming queue and a second arming queue, and the first arming queue is to arm the second arming queue, and the second arming queue is to arm the first arming queue.

There is also provided in accordance with another exemplary embodiment of the present invention a method for packet transmission including performing the following in timing circuitry, the timing circuitry including an arming queue, a clock work queue, and a clock completion queue: the clock work queue providing timing information, and the arming queue arming the clock work queue.

Further in accordance with an exemplary embodiment of the present invention the clock work queue synchronizes a sending time of packets pointed to by entries in a send queue to hold entries pointing to packets to be transmitted, via interaction with the clock completion queue.

Still further in accordance with an exemplary embodiment of the present invention the send queue is associated with an application running in a host external to the timing circuitry.

Additionally in accordance with an exemplary embodiment of the present invention the send queue includes a plurality of send queues each of which is associated with an application running in a host external to the timing circuitry.

Moreover in accordance with an exemplary embodiment of the present invention the method also includes, in packet sending circuitry, transmitting one or more packets over a network, wherein the packet sending circuitry transmits the one or more packets in accordance with the sending time of corresponding entries in the send queue.

Further in accordance with an exemplary embodiment of the present invention the arming queue includes at least a first arming queue and a second arming queue, and the method also includes the first arming queue arming the second arming queue, and the second arming queue arming the first arming queue.

Still further in accordance with an exemplary embodiment of the present invention the timing circuitry is included in a network interface card (NIC).

Additionally in accordance with an exemplary embodiment of the present invention the packet sending circuitry and the timing circuitry are included in a network interface card (NIC).

There is also provided in accordance with another exemplary embodiment of the present invention a timing system including a host system including a clock work queue and a clock completion queue, and timing circuitry in operative communication with the host system and including an arming queue, wherein at least the clock work queue is to provide timing information, and the arming queue is to arm the clock work queue.

Further in accordance with an exemplary embodiment of the present invention the clock completion queue is also to provide timing information.

Still further in accordance with an exemplary embodiment of the present invention the clock work queue is for synchronizing a sending time of packets pointed to by entries in a send queue to hold entries pointing to packets to be transmitted, via interaction with the clock completion queue.

Additionally in accordance with an exemplary embodiment of the present invention at least one of the clock work queue and the clock completion queue is implemented in firmware.

Moreover in accordance with an exemplary embodiment of the present invention the send queue includes a plurality of send queues each of which is associated with an application running in the host, and a least one application is associated with a different protection domain than at least one other application.

### BRIEF DESCRIPTION OF THE DRAWINGS

The present invention will be understood and appreciated more fully from the following detailed description, taken in conjunction with the drawings in which:

FIG. 1A is a simplified block diagram illustration of a clock queue-based system, constructed and operative in accordance with an exemplary embodiment of the present invention;

FIG. 1B is a simplified block diagram illustration of a clock queue-based system, comprising an alternative exemplary embodiment of the system of FIG. 1A;

FIG. 2A is a simplified block diagram illustration of a clock queue-based system, constructed and operative in accordance with an exemplary embodiment of the present invention;

FIG. 2B is a simplified block diagram illustration of a clock queue-based system, comprising an alternative exemplary embodiment of the system of FIG. 2A;

FIG. 3A is a simplified block diagram illustration of a particular example of the clock queue-based system of FIG. 2A;

FIG. 3B is a simplified block diagram illustration of a particular example of the clock queue-based system of FIG. 2B;

FIG. 4A is a simplified block diagram illustration of a clock queue-based system, constructed and operative in accordance with an exemplary embodiment of the present invention;

FIG. 4B is a simplified block diagram illustration of a clock queue-based system, comprising an alternative exemplary embodiment of the system of FIG. 4A; and

FIGS. 5-7 are simplified flowchart illustrations of exemplary modes of operation of exemplary embodiments of the present invention.

### DETAILED DESCRIPTION OF AN EMBODIMENT

As described in U.S. patent application Ser. No. 16/430,457 of Levi et al, published as US Published Patent Application 2019/0379714, the disclosure of which has been incorporated herein by reference:
A “send enable” work request (which may comprise a work queue element (WQE), as is known in InfiniBand) is posted to a so-called “master” send queue. The posted WQE has a form/contents which indicated that a WQE from a “different” queue (not from the master send queue) should be executed and sent. In the meantime, in the “different” queue, a slave send queue, WQEs are posted indicating that data should be sent. However, continuing with the present example, in the slave queue no doorbell is executed, so the WQEs in the slave queue are not executed and sent at the time that the WQEs are posted; such doorbell/s are generally sent to a network interface controller (NIC) which has access to the queues and to memory pointed to by WQEs. In the meantime a hardware packing mechanism causes doorbells to be generated by the NIC (generally every short and deterministic period of time, such as for example every few nanoseconds); these doorbells are executed in the master queue, causing NOP WQEs (each of which produces a delay as specified above) to be executed; finally, when the “send enable” work request in the master send queue is executed, this causes a doorbell to be issued to the slave queue, and the WQEs therein are then executed, causing data (packets) indicated by the slave queue WQEs to be sent. Thus, the master queue synchronizes send of data based on the WQEs in the slave queue.
   The solution described immediately above may create many queues, because there is master queue per slave queue, and hence one master queue per stream of packets to be sent. An alternative solution may be implemented as follows, with all streams for a given bit rate being synchronized to a master queue for that bit rate:
   For every specific synchronization interval (that is, for every given time desired between doorbells in a slave queue, the doorbells causing, as described above, data packets to be sent) a reference queue (“master” queue) is established, containing a constant number of NOP work requests followed by a send enable work request. In the particular non-limiting example in which a NOP work request has the same transmission time as 8 bits and therefore represents 8 bits of delay (with the same being true for a send enable work request), then:

$$\frac{( ( number of NOP plus Send Enable work requests ) * 8 bits )}{bitrate}$$

should be exactly equal to the synchronization interval (to an accuracy of the transmission time of 8 bits). If higher accuracy is needed, the bitrate for the “master” queue and the number of NOP work requests could be increased in order to increase accuracy.
   After the NOP work requests as described above have been posted, the send enable work request as described above is posted. The send enable work request sends a doorbell to each slave queue, such that each slave queue will send data packets in accordance with the WQEs therein.
   Dedicated software (which could alternatively be implemented in firmware, hardware, etc.) indefinitely continues to repost NOP and send enable work requests to the “master” queue, so that the process continues with subsequent synchronization intervals; it being appreciated that if no more data packets are to be sent, the dedicated software may cease to post NOP and send enable work requests in the “master” queue (which ceasing may be based on user intervention).
   From the above description it will be appreciated that the software overhead in this alternative solution is per synchronization period, not per transmitted queue, nor per bitrate.
   With reference to the above-described embodiments, alternatively the doorbell sent to the slave queue or queues may be sent when a completion queue entry (CQE) is posted to a completion queue, after processing of a send enable WQE.

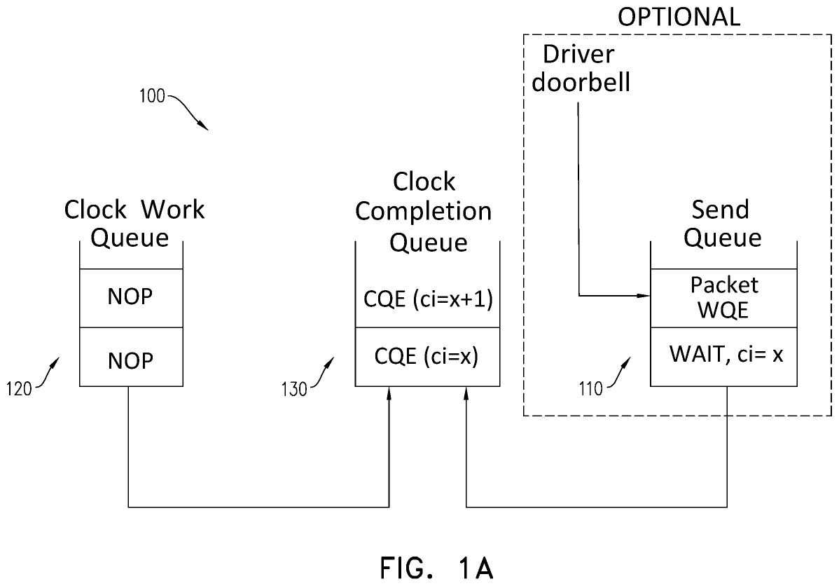

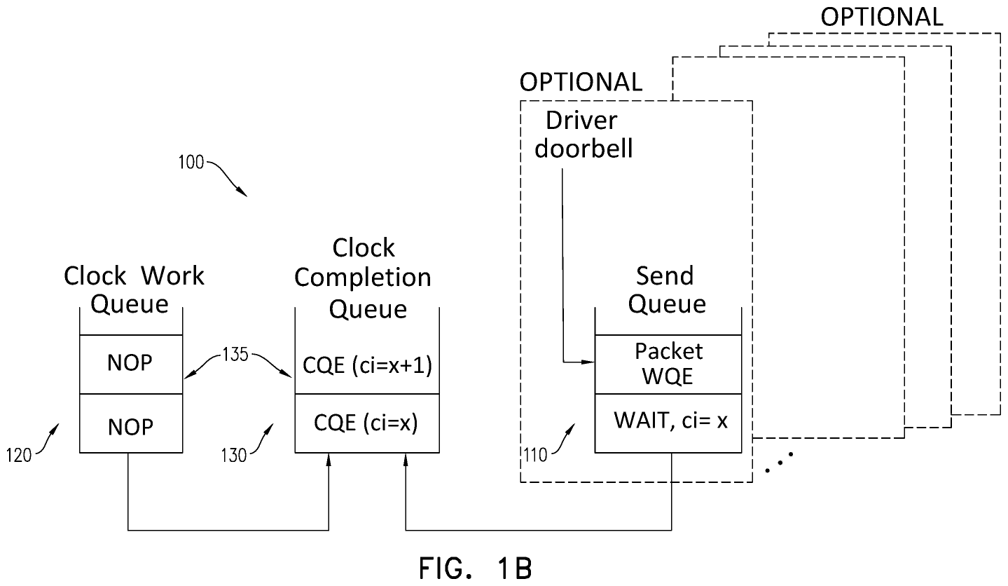

Reference is now made to FIG. 1A, which is a simplified block diagram illustration of a clock queue-based system, constructed and operative in accordance with an exemplary embodiment of the present invention. The system of FIG. 1A is generally, but not necessarily, comprised in a network interface card (NIC), it being appreciated that other suitable embodiments (which, in light of the present description, will be evident to persons skilled in the art) are also possible. In the system of FIG. 1A, similarly to what is described immediately above with reference to U.S. patent application Ser. No. 16/430,457 of Levi et al, a system generally designated 100 is illustrated.

The system 100 includes a clock work queue 120, which is a work queue that has been posted with dummy commands (NOP descriptors); these NOP descriptors are used for packet rate enforcement. In some exemplary embodiments, the commands posted to the clock work queue may not necessarily be NOP commands; other commands may also lead to the desired packet rate enforcement behavior. For simplicity of depiction and description and without limiting the generality of the foregoing, NOP commands are generally described herein.

In general, the system 100 will trigger every “clock-tick” time. If, by way of non-limiting example, the clock-tick is 500 nanoseconds, the system 100 will execute 2 million commands per second in the clock work queue 120, in order to maintain the desired pace.

It will be appreciated that it will be necessary to re-post the NOP commands to the clock work queue 120 (typically by software; although alternatively, by way of non-limiting example, by firmware) every Queue-size/2 time, in order for the system 100, and in particular the clock queue 120, to run indefinitely. The NIC (or other system in which the system 100 is embedded) is configured not to check the NOP index, thereby to allow the software (for example) to write only a single NOP command into the clock work queue 120, and only update the door-bell record to send additional clock-queue-size/2 commands. The preceding is true since (in a typical case) all commands in the clock work queue 120 are the same, so that the clock work queue 120 may hold a single command with index 0, but a HW doorbell register (not shown) is armed to execute 16,000 such commands (by way of non-limiting example). In order to accomplish this, the system 100 is configured not to check the index of commands in the clock work queue 120, so that the system 100 will execute the same NOP command 16,000 times. While so operating, the system 100 will incrementing internally a “producer index” (pi, producer indexes being well known in the art) which is wrapped around at some maximum index value (such as, by way of non-limiting example, 16,000) and therefore the HW cannot be armed for more than 16,000 commands at once. In practice, actual limits (as opposed to 16,000) are generally an exact power of 2, such as, by way of non-limiting example, 16,384.

As just discussed, a typical size in entries of the clock work queue 120 would be 16K (16,384); at such a size, the software (for example) would need to arm (reload) the clock work queue 120 for every 8K commands that executed. It will be appreciated that 8K commands at a pace of 2 million commands per second represent a 4-millisecond interval. This would mean, in a software implementation, that software will have to “wake up” every 4 milliseconds to re-arm the clock work queue 120. In addition to CPU involvement in running such software, there is an important real-time restriction, since in the described scenario the software must wake up every 4 milliseconds. If the software woke up too late, the clock queue 120 will become empty (stop ticking), having a very negative impact on the reliability of the system 100.

In addition, the inventors of the present invention believe that real-time requirements on software are extremely problematic, since such requirements are not functional requirements, and (to ensure reliability) should be tested against any contemplated actual system, in any load that the contemplated actual system is intended to run. Such a requirement is believed to be extremely problematic and challenging, and would add a significant cost to the system 100.

The system of FIG. 1A also comprises a clock completion queue 130, which contains an entry for the completion of each NOP command execution. Each such completion is generated every clock tick.

It is appreciated that one or both of the clock work queue 120 and the clock completion queue 130 may alternatively be situated in a host external to the system 100 and in operative communication therewith. It is also appreciated that each of the clock work queue 120 and the clock completion queue 130 may be implemented either in software or in firmware.

The system of FIG. 1A also optionally (optionally in certain exemplary embodiments) comprises a work queue (send queue) 110, which contains descriptors to data, which needs to be accurately transmitted “to the wire” (to exit the system, such as a NIC, in which the system 100 of FIG. 1A is comprised, for network transmission) at a specific network time. The work queue 110 may, in certain exemplary embodiments, serve a particular application running on a host with which the system 100 is in operative communication.

It is appreciated that, while not shown in any of FIGS. 1A-4B, the systems of FIGS. 1A-4B each generally (but optionally) comprise a packet sending module or circuitry, as is known in the art, for sending packets “to the wire”. More precisely, the specific time as described may be considered to be “do not transmit before a specific time”. The “fencing” (accurate scheduling) of transmission is done by a special command that fences the execution until a specific index of a completion message is generated.

The inventors of the present invention believe that the system described in U.S. patent application Ser. No. 16/430,457 of Levi et al, which has been incorporated herein by reference (and similarly the system of FIG. 1A described immediately above) has certain drawbacks which are intended to be overcome in certain exemplary embodiments of the present invention. In particular (referring to FIG. 1A by way of non-limiting example), it would be necessary to repost packets to the clock queue 120 and to arm the doorbell record. (It is noted that the “doorbell record” referred to here is well known in the art, and is not shown in the drawings; it is a static entity implemented for example as a set of registers for each queue holding for that queue a consumer index ci and a producer index pi. The consumer index indicates how many jobs (tasks) have been completed, while the pi indicates how many jobs have been published for execution. When ci=pi there is no more work to do at the present time).

Generally speaking, such operations would take place under software control and would consume significant resources. Moreover, such operations would need to be “real time” in software terms, so that each queue of a given pace would need to be armed in accordance with a different real time pace. In a realistic scenario, a system would handle (by way of non-limiting example) 2 million packets per second. The inventors of the present invention further believe that, in a software-implemented system, changes (such as changes in clock rate/pace or addition of a clock at a new rate/pace) would cause a need to retest software due to the new burdens placed on the software. The present invention, in exemplary embodiments thereof, is intended to overcome such limitations, particularly, but not exclusively, by being designed to minimize or even eliminate software resources in reposting and arming as described above (in particular, with respect to the above discussion of real-time requirements in software).

Reference is now additionally made to FIG. 1B, which is a simplified block diagram illustration of a clock queue based system, comprising an alternative exemplary embodiment of the system of FIG. 1A. The system of FIG. 1B is similar to the system of FIG. 1A, except that for a subsystem 135 (comprising the clock work queue 120 and the clock completion queue 130) there may be a plurality of work queues 110 each of which, in certain exemplary embodiments, may serve a particular application running on a host with which the system 100 is in operative communication, such that a plurality of applications may be served by the subsystem 135.

The concept of memory protection (which is described, for example, in en.wikipedia.org/wiki/Memory_protection) may be useful in understanding the exemplary embodiment of FIG. 1B, as well as certain other exemplary embodiments of the present invention. In general, any given application will be associated with a particular protection domain; and different applications may be associated with different protection domains. In some cases, if the subsystem 135 is implemented in software, then in order to access the subsystem 135, that given application would generally need to be in the same protection domain as the subsystem 135. On the other hand, if the subsystem 135 is implemented in firmware, then the subsystem 135 will generally be in a trusted zone, and hence access between the subsystem 135 and any given application will be possible regardless of the particular protection domain with which the given application is associated. The previous explanation regarding a plurality of applications also applies, mutatis mutandis, to a plurality of virtual environments, such as virtual machines.

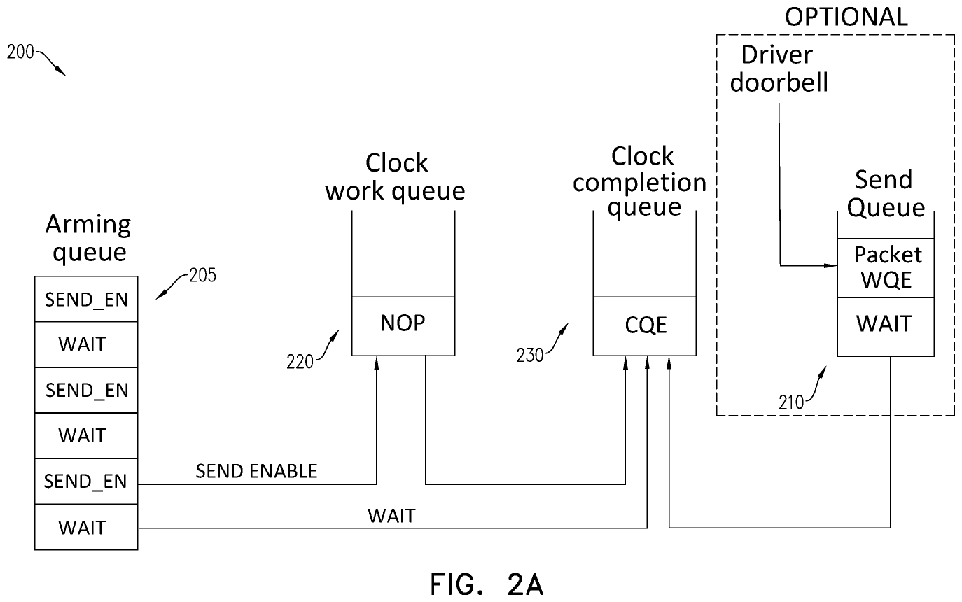

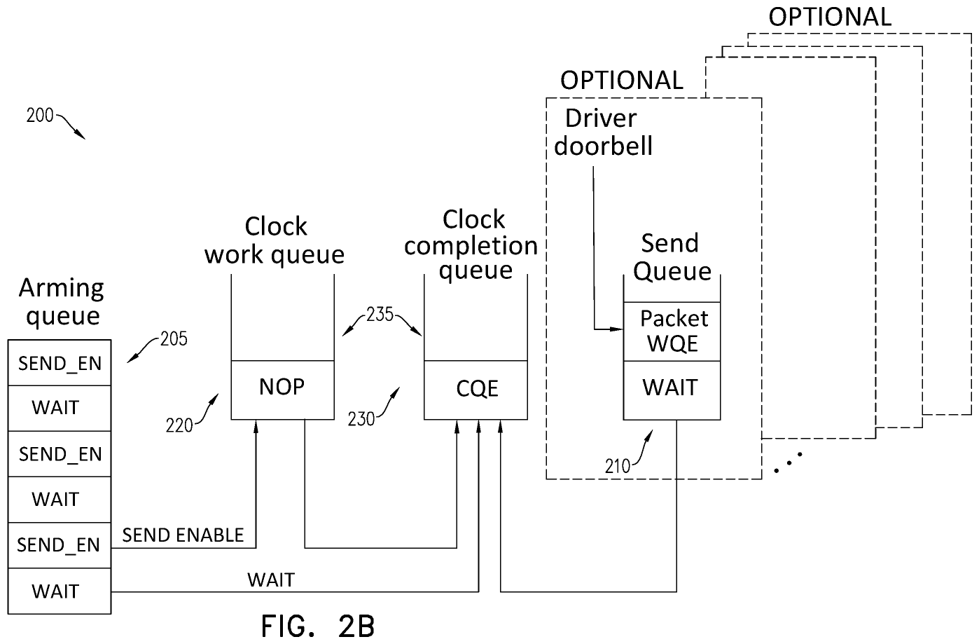

Reference is now made to FIG. 2A, which is a simplified block diagram illustration of a clock queue-based system, constructed and operative in accordance with an exemplary embodiment of the present invention.

The system of FIG. 2A, generally designated 200, is similar to the system of FIG. 1A except as described below; the system of FIG. 2A comprises a send queue 210 (which is optional in certain exemplary embodiments) similar to the send queue 110 of FIG. 1A, a clock work queue 220 similar to the clock work queue 110 of FIG. 1A, and a clock completion queue 230 similar to the clock completion queue 130 of FIG. 1A.

Additionally, the system 200 of FIG. 2A comprises an arming queue 205. The arming queue 205 is constructed and operative to arm the clock work queue 220, thus simplifying the process described above for reposting and arming.

The arming queue 205 is posted with 2 different commands one after the other, repeatedly. One such command is a “wait” command. By way of non-limiting example, the wait command may be an instruction to wait for the next index which is 8000 greater than a current index in the clock work queue 220. Typically, this would represent a 4 microsecond wait period. The other command is a “send enable” command, which is a command to trigger a further 8000 doorbell records in the clock work queue 220. The action here described replaces the action described above as taking place in software; it will appreciate that this action does not require software intervention.

As here described (by way of non-limiting example), the arming queue 205 need be triggered every 8000×4 milliseconds=32 sec; it is appreciated that such a requirement (triggering once every 32 seconds by software) represents negligible overhead. In other words, if software is required to carry out such a task only once every 32 seconds, there is no real-time requirement on the software, and the problems stated above with regard to real-time requirements on software are deemed to be overcome.

Reference is now additionally made to FIG. 2B, which is a simplified block diagram illustration of a clock queue-based system, comprising an alternative exemplary embodiment of the system of FIG. 2A. The system of FIG. 2B is similar to the system of FIG. 2A, except that for a subsystem 235 (comprising the clock work queue 220 and the clock completion queue 230) there may be a plurality of work queues 210 each of which, in certain exemplary embodiments, may serve a particular application running on a host with which the system 200 is in operative communication, such that a plurality of applications may be served by the subsystem 235.

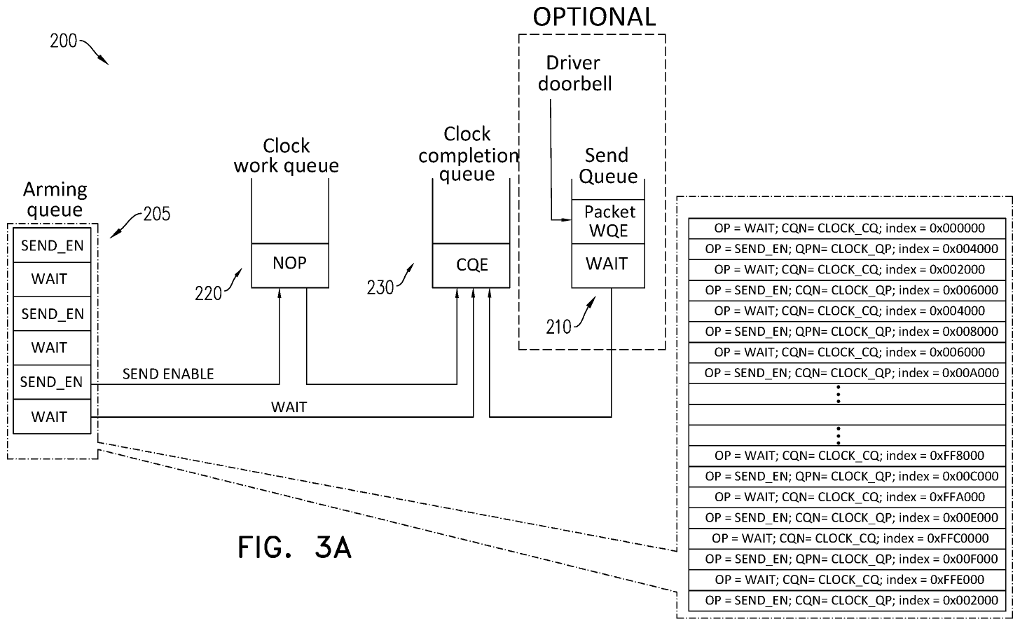

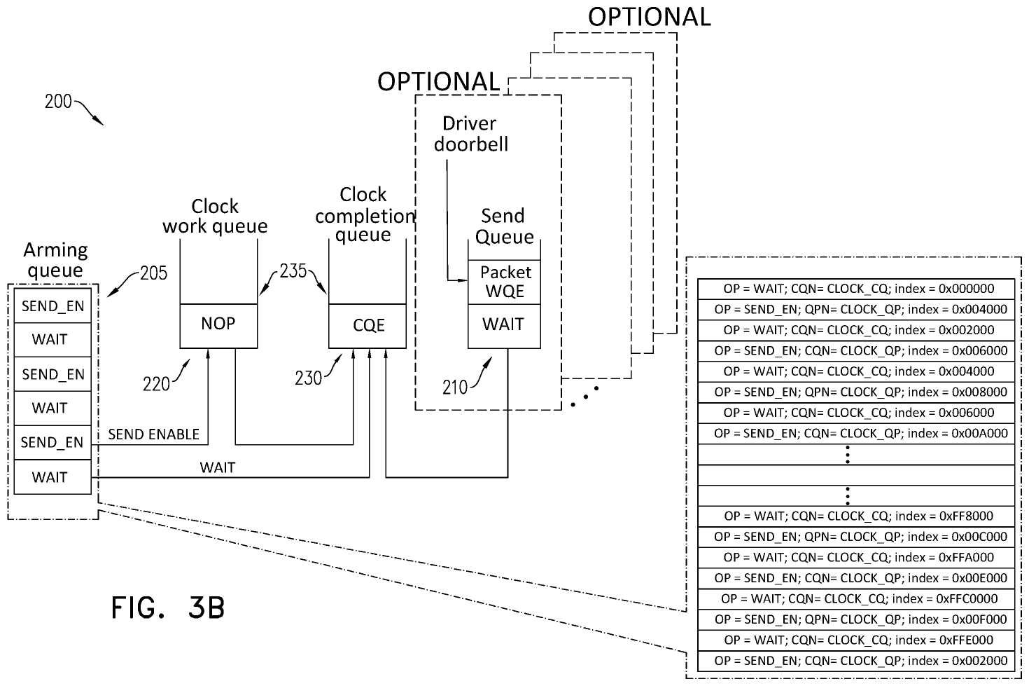

Reference is now additionally made to FIG. 3A, which is a simplified block diagram illustration of a particular example of the clock queue-based system of FIG. 2A; and to FIG. 3B, which is a simplified block diagram illustration of a particular example of the clock queue-based system of FIG. 2B. The examples of FIGS. 3A and 3B shows in detail exemplary queue entries in the arming queue 305, with alternating send_enable entries (each entry indicating and index 8000 greater than the previous entry) and wait entries (each indicating a wait for a next index which is 8000 greater than the previous).

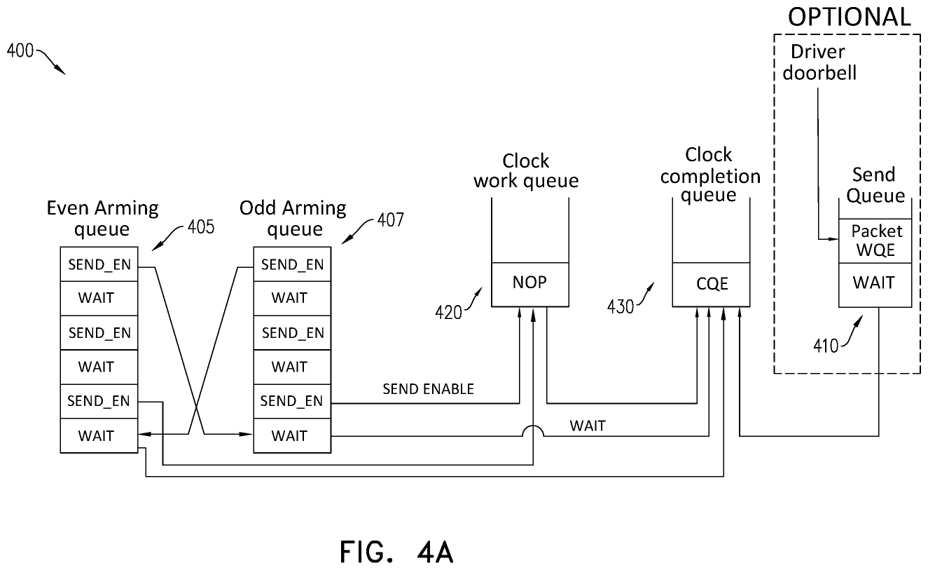

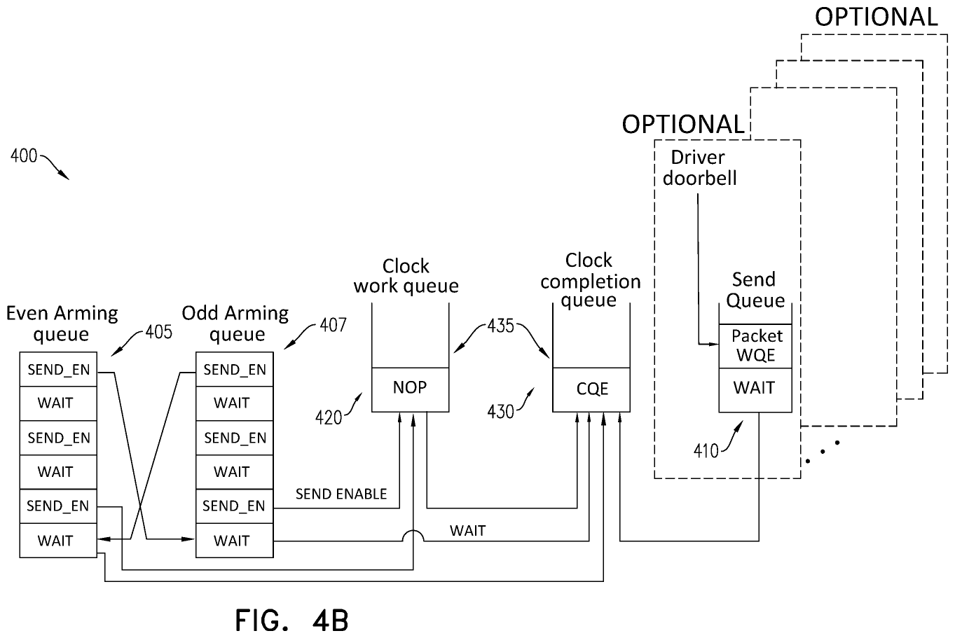

Reference is now made to FIG. 4A, which is a simplified block diagram illustration of a clock queue-based system, constructed and operative in accordance with an exemplary embodiment of the present invention.

The system of FIG. 4A, generally designated 400, is similar to the system of FIG. 2A except as described below; the system of FIG. 4A comprises a send queue 410 (which may in certain exemplary embodiments be optional) similar to the send queue 210 of FIG. 2A, a clock work queue 420 similar to the clock work queue 210 of FIG. 2A, and a clock completion queue 430 similar to the clock completion queue 330 of FIG. 2A.

In the system of FIG. 4A, compared to the system of FIG. 2A, the arming queue 205 of FIG. 2A has been replaced with an even arming queue 405 and an odd arming queue 407.

In the system 400, with two arming queues (the even arming queue 405 and the odd arming queue 407), each of the two arming queues contain waits and send_enable entries as described above with reference to FIG. 2A. In addition, at the end of each arming queue (the even arming queue 405 and the odd arming queue 407) there is an additional send_enable command which is operative to arm the “other” arming queue (the even arming queue 405 arms the odd arming queue 407 and vice versa). Thus, in the system 400 the system is “self-arming” indefinitely, so that no software operation is needed.

Persons skilled in the art will appreciate that, for simplicity of depiction and description, two arming queues (the even arming queue 405 and the odd arming queue 407) are described; in principal, three or more such queues may be used.

Reference is now additionally made to FIG. 4B, which is a simplified block diagram illustration of a clock queue-based system, comprising an alternative exemplary embodiment of the system of FIG. 4A. The system of FIG. 4B is similar to the system of FIG. 4A, except that for a subsystem 435 (comprising the clock work queue 420 and the clock completion queue 430) there may be a plurality of work queues 410 each of which, in certain exemplary embodiments, may serve a particular application running on a host with which the system 400 is in operative communication, such that a plurality of applications may be served by the subsystem 435.

The various components comprised in the systems 100, 200, 300, and 400 and described above may also be termed herein, separately and/or collectively, “circuitry”.

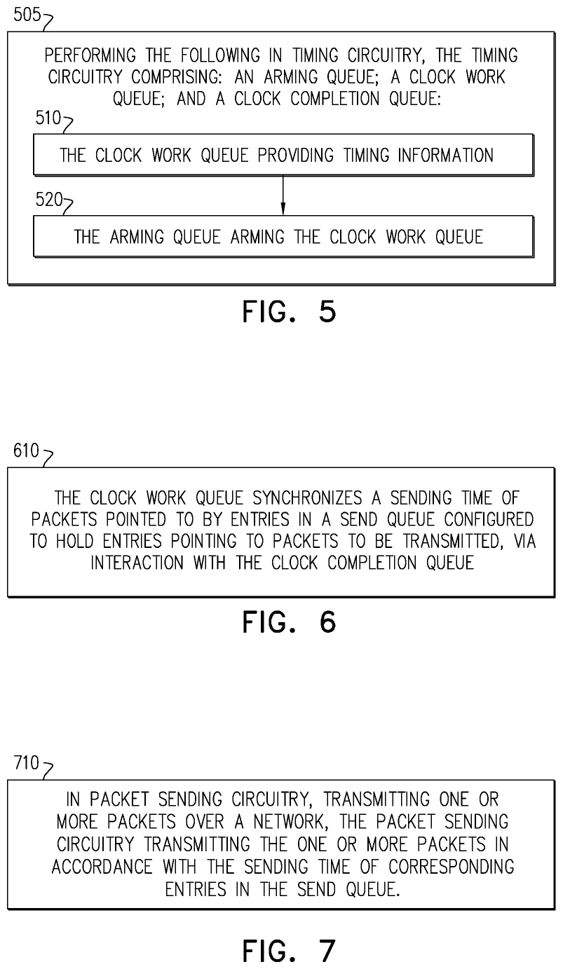

Reference is now made to FIGS. 5-7, which are simplified flowchart illustrations of exemplary modes of operation of exemplary embodiments of the present invention. FIG. 5 represents an exemplary mode of operation, with FIGS. 6 and 7 representing further steps that may be added to the method of FIG. 5.

FIGS. 5-7 will be best understood with reference to the above discussion of FIGS. 2A-4B.

The method of FIG. 5 comprises the following steps which, as indicated in step 505, are performed in timing circuitry which comprises an arming queue, a clock work queue, and a clock completion queue.

The clock work queue provides timing information (step 510), while the arming queue arms the clock work queue (step 520). In certain embodiments, the clock completion queue may also provide timing information.

In FIG. 6, the clock work queue (additionally to the steps of FIG. 5) synchronizes a sending time of packets. The packets are pointed to by entries in a send queue. The send queue, in turn, is configured to hold entries pointing to packets to be transmitted. The synchronization occurs via interaction with the clock completion queue (step 610).

In FIG. 7 (additionally to the steps of FIG. 5 plus FIG. 6), packet sending circuitry transmits one or more packets over a network. The packet sending circuitry transmits the one or more packets in accordance with the sending time of corresponding entries in the send queue (step 710).

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A communication system, comprising:
at least one send queue, containing send queue entries pointing to packets to be transmitted over a network by packet sending circuitry;
a clock work queue, containing clock queue entries to synchronize sending times of the packets pointed to by the send queue entries; and
at least one arming queue containing arming queue entries to arm the clock work queue at selected time intervals.

2. The system according to claim 1, and comprising a clock completion queue, wherein the clock queue entries synchronize the sending times of the packets by generating completion queue entries in the clock completion queue.

3. The system according to claim 1, wherein the arming queue entries comprise send enable work requests, which arm the clock work queue.

4. The system according to claim 3, wherein the arming queue entries further comprise wait commands defining the selected time intervals.

5. The system according to claim 3, wherein the send enable work requests trigger a selected number of doorbell records in the clock work queue for synchronizing the sending times of the packets pointed to by the send queue entries.

6. The system according to claim 1, wherein the system comprises a network interface controller (NIC).

7. The system according to claim 6, wherein the at least one send queue is associated with at least one application running on a host external to the NIC.

8. The system according to claim 7, wherein the at least one send queue comprises a plurality of send queues, which are associated with respective applications running on the host.

9. The system according to claim 8, wherein a least one of the applications is associated with a different protection domain from at least one other of the applications.

10. The system according to claim 1, wherein the at least one arming queue comprises at least a first arming queue and a second arming queue, wherein the first arming queue is to arm the second arming queue, and the second arming queue is to arm the first arming queue.

11. A method for communication, comprising:
transmitting packets over a network by packet sending circuitry in response to reading send queue entries pointing to the packets from at least one send queue;
synchronizing sending times of the packets pointed to by the send queue entries by reading clock queue entries from a clock work queue; and
arming the clock work queue at selected time intervals in response to arming queue entries read from at least one arming queue.

12. The method according to claim 11, wherein the clock queue entries synchronize the sending times of the packets by generating completion queue entries in a clock completion queue.

13. The method according to claim 11, wherein the arming queue entries comprise send enable work requests, which arm the clock work queue.

14. The method according to claim 13, wherein the arming queue entries further comprise wait commands defining the selected time intervals.

15. The method according to claim 13, wherein the send enable work requests trigger a selected number of doorbell records in the clock work queue for synchronizing the sending times of the packets pointed to by the send queue entries.

16. The method according to claim 1, wherein the packet sending circuitry is a part of a network interface controller (NIC).

17. The method according to claim 16, wherein the at least one send queue is associated with at least one application running on a host external to the NIC.

18. The method according to claim 17, wherein the at least one send queue comprises a plurality of send queues, which are associated with respective applications running on the host.

19. The method according to claim 18, wherein a least one of the applications is associated with a different protection domain from at least one other of the applications.

20. The method according to claim 1, wherein the at least one arming queue comprises at least a first arming queue and a second arming queue, wherein the first arming queue is to arm the second arming queue, and the second arming queue is to arm the first arming queue.
